(19) United States
(12) Patent Application Publication
(10) Pub. No.: US 2026/0324673 A1
(43) Pub. Date: Oct. 22, 2026

(54) MULTIFUNCTIONAL ICE BEVERAGE MACHINES

(71) Applicant: GUANGDONG SHINECHEF ELECTRIC APPLIANCE CO., LTD., Foshan (CN)

(72) Inventor: Jiang HU, Foshan (CN)

(73) Assignee: GUANGDONG SHINECHEF ELECTRIC APPLIANCE CO., LTD., Foshan (CN)

(21) Appl. No.: 19/313,031

(22) Filed: Aug. 28, 2025

(30) Foreign Application Priority Data
Apr. 16, 2025 (CN) 202510473120.1

(51) Int. Cl. A23G 9/04; A23G 9/12; A23G 9/28; F25C 1/22

(52) U.S. Cl. CPC A23G 9/045; A23G 9/12; A23G 9/283; F25C 1/22; F25C 2400/14; F25C 2600/02; F25C 2700/14

(57) ABSTRACT

Provided is a multifunctional ice beverage machine. The multifunctional ice beverage machine includes a housing, an ice cube forming assembly, a slush beverage forming assembly, and a refrigeration assembly. The ice cube forming assembly includes a first evaporator. A surface of the first evaporator is provided with grooves. The slush beverage forming assembly includes a second evaporator, a drive motor, and a scraper. The drive motor is connected to the second evaporator and drives the second evaporator to roll about an axis of the second evaporator. The scraper is disposed on a side wall of the second evaporator. The refrigeration assembly includes a compressor and a condenser, the compressor is in fluid connection with the first evaporator and the second evaporator through the condenser.

### CROSS-REFERENCE TO RELATED APPLICATIONS

This application claims priority to Chinese application No. 202510473120.1 filed Apr. 16, 2025, the entire contents of which are incorporated herein by reference.

### TECHNICAL FIELD

The present disclosure relates to the technical field of household appliance devices, and in particular, to multifunctional ice beverage machines.

### BACKGROUND

An ice beverage machine, as an automated device integrating ice-making and beverage preparation functions, is capable of completing an entire process of cold beverage preparation using a single device. However, existing ice beverage machines suffer from the following technical limitations in practical applications. 1. Single-form ice beverages: existing ice beverage machines typically adopt separate ice trays and beverage storage tanks, requiring manual or automated mixing of ice granules and liquid beverages during preparation. This design makes it difficult to meet the demand for diversified ice beverage forms using a single device, thereby limiting users'flexibility in different scenarios and use requirements. 2. Large size: the existing ice beverage machines are mostly designed for commercial use, resulting in a relatively large overall size, which makes them unsuitable for typical households or portable scenarios. This limitation leads to significant applicability issues for home or mobile use. In summary, the existing ice beverage machines are notably insufficient in terms of functional diversity and portability, and there is an urgent need for technical improvements to overcome the above-mentioned shortcomings.

### SUMMARY

The present disclosure provides a multifunctional ice beverage machine, which addresses the issues found in existing ice beverage machines, such as limited beverage variety, large size, low portability, etc.

Embodiments of the present disclosure provides a multifunctional ice beverage machine. The multifunctional ice beverage machine includes a housing, an ice cube forming assembly, a slush beverage forming assembly, and a refrigeration assembly. The ice cube forming assembly includes a first evaporator and an ice receiving basket, a surface of the first evaporator is provided with grid-like grooves, the ice receiving basket is located on a lower side of the first evaporator along a direction of gravity, the ice receiving basket is configured as a drawer-type basket and slidably inserted into the housing. The slush beverage forming assembly includes a second evaporator, a drive motor, and a scraper. The drive motor is connected to the second evaporator and drives the second evaporator to roll about an axis of the second evaporator. The scraper is disposed on a side wall of the second evaporator to detach a solidified ice beverage from the side wall of the second evaporator to form a slush. The refrigeration assembly includes a compressor and a condenser, the compressor is in fluid connection with the first evaporator and the second evaporator through the condenser. An interior of the housing includes a first chamber, a second chamber, and a third chamber adjacent to each other. The compressor and the condenser are disposed in the first chamber, the first evaporator is disposed in the second chamber, and the second evaporator is disposed in the third chamber

### BRIEF DESCRIPTION OF THE DRAWINGS

FIG. 1 is a schematic diagram illustrating an internal structure of a multifunctional ice beverage machine according to some embodiments of the present disclosure;

FIG. 2 is a perspective view of the multifunctional ice beverage machine according to some embodiments of the present disclosure;

FIG. 3 is a schematic diagram of the multi-functional ice beverage machine shown in FIG. 1 from another perspective;

FIG. 4 is a schematic diagram illustrating a connection between a drying filter and a capillary tube according to some embodiments of the present disclosure;

FIG. 5 is a simplified structural schematic of the multifunctional ice beverage machine according to some embodiments of the present disclosure;

FIG. 6 is a schematic diagram illustrating pipeline connections among an ice cube forming assembly, a slush beverage forming assembly, and a refrigeration assembly according to some embodiments of the present disclosure;

FIG. 7 is a schematic diagram illustrating a pre-folding configuration of a multifunctional ice beverage machine according to other embodiments of the present disclosure;

FIG. 8 is a schematic diagram illustrating a post-folding configuration of the multifunctional ice beverage machine according to other embodiments of the present disclosure;

FIG. 9 is a schematic diagram illustrating a structure of the multifunctional ice beverage machine before folding according to other embodiments of the present disclosure;

FIG. 10 is a schematic diagram illustrating a structure of the multifunctional ice beverage machine after folding according to other embodiments of the present disclosure;

FIG. 11 is a schematic diagram illustrating a cooperation between a water tank and a liquid temporary-storage assembly according to some embodiments of the present disclosure; and

FIG. 12 is a schematic diagram illustrating an exemplary structure of an ice-making mold according to some embodiments of the present disclosure.

### DETAILED DESCRIPTION

The present disclosure is described in detail below with reference to the accompanying drawings and specific embodiments. These embodiments are implemented based on the technical solutions of the present disclosure and provide detailed implementation methods and specific operational procedures. However, the scope of protection of the present disclosure is not limited to the following embodiments.

Terms such as “first,” “second,” etc., are used only for distinguishing descriptions and should not be construed as indicating or implying relative importance.

In the description of the embodiments, it should also be noted that, unless otherwise explicitly specified and defined, the terms “arranged,” “connected,” and “coupled” should be interpreted broadly. For example, a connection may be fixed or detachable, or integrally formed; it may be a mechanical connection or an electrical connection; it may be a direct connection or an indirect connection through an intermediary, or it may refer to internal communication between two components. Those of ordinary skill in the art can understand the specific meanings of these terms in the present embodiments based on the actual context.

To make the objectives, technical solutions, and advantages of the present disclosure clearer, the embodiments of the present disclosure will be further described in detail below with reference to the accompanying drawings.

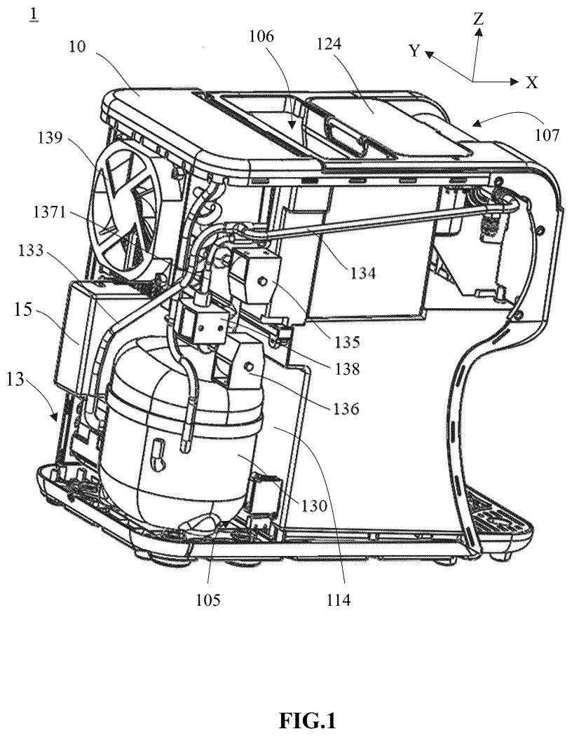

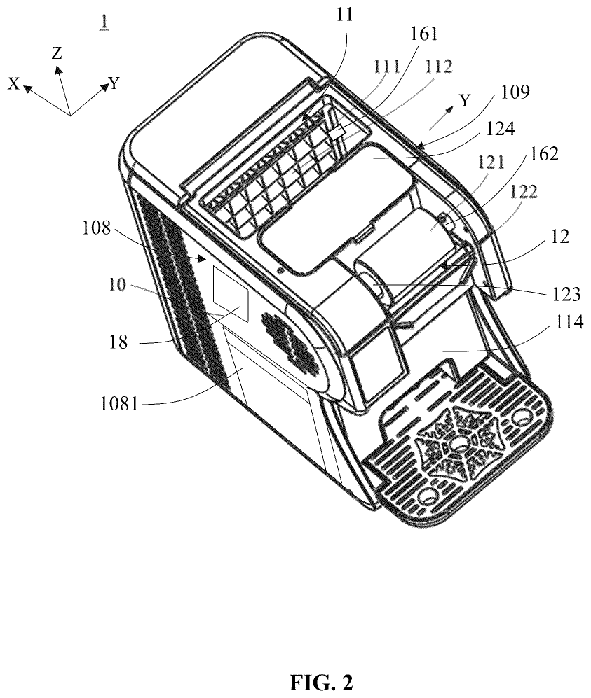

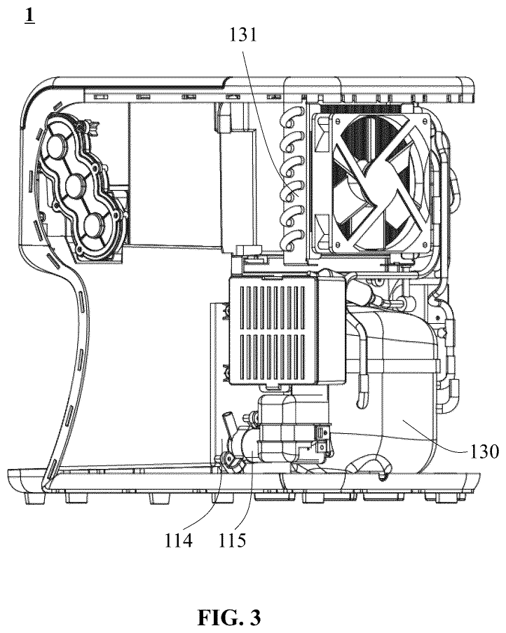

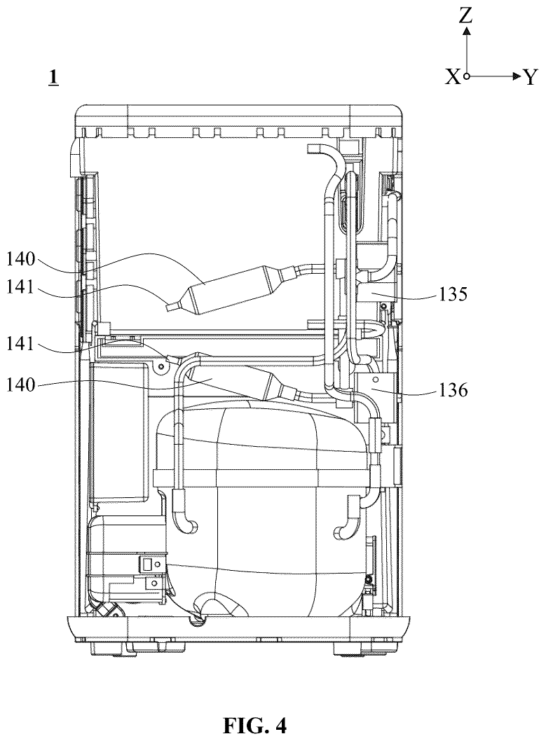

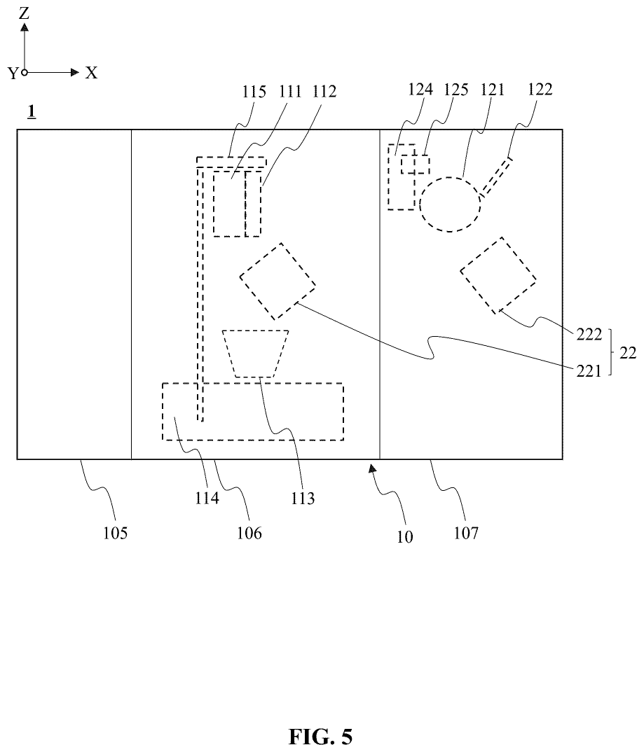

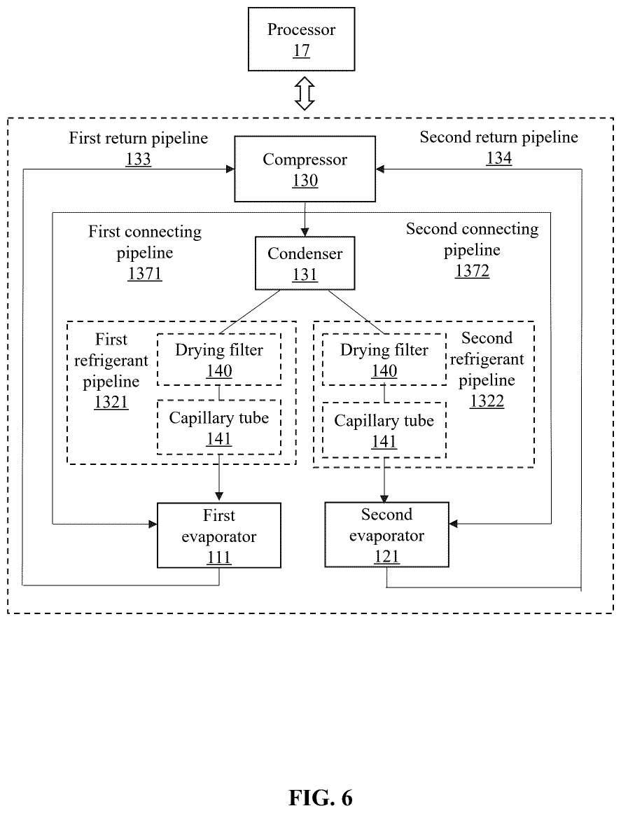

FIG. 1 is a schematic diagram illustrating an internal structure of a multifunctional ice beverage machine according to some embodiments of the present disclosure. FIG. 2 is a perspective view of the multifunctional ice beverage machine according to some embodiments of the present disclosure. FIG. 3 is a schematic diagram of the multi-functional ice beverage machine shown in FIG. 1 from another perspective. FIG. 4 is a schematic diagram illustrating a connection between a drying filter and a capillary tube according to some embodiments of the present disclosure. FIG. 5 is a simplified structural schematic of the multifunctional ice beverage machine according to some embodiments of the present disclosure. FIG. 6 is a schematic diagram illustrating pipeline connections among an ice cube forming assembly, a slush beverage forming assembly, and a refrigeration assembly according to some embodiments of the present disclosure.

The present disclosure provides a multifunctional ice beverage machine 1. As shown in FIG. 1 to FIG. 6, the multifunctional ice beverage machine 1 includes a housing 10, an ice cube forming assembly 11, a slush beverage forming assembly 12, and a refrigeration assembly 13. The ice cube forming assembly 11 refers to an assembly for making ice cubes. The slush beverage forming assembly 12 refers to a component for making slushes. The refrigeration assembly 13 refers to a component that provides cold for making the ice cubes and slushes.

In some embodiments, the ice cube forming assembly 11, the slush beverage forming assembly 12, and the refrigeration assembly 13 are disposed in the housing 10.

The ice cube forming assembly 11 includes a first evaporator 111. The evaporator refers to a structure that allows a liquid to exchange heat and freeze. In some embodiments, as shown in FIG. 2, a surface of the first evaporator 111 is provided with grid-like grooves 112. The grid-like grooves 112 refer to grooves 112 arranged in a grid-like shape. The liquid in the groove 112 may undergo heat exchange through the first evaporator 111, thereby solidifying into the ice cubes. The present disclosure does not limit to a shape of the grooves 112. For example, the shape of the grooves 112 may be hemispherical, rectangular, polygonal, heart-shaped, pentagon-shaped, diamond-shaped, or the like. The shape of the grooves 112 refers to a contour profile of the grooves 112. In some embodiments, the grooves 112 are wedge-shaped or trapezoidal. In some embodiments, the ice cube forming assembly 11 further includes an ice receiving basket 113. The ice receiving basket 113 is disposed on a lower side of the first evaporator 111 along a direction of gravity, and the ice receiving basket 113 is a configured as a drawer-type basket and slidably inserted into the housing 10. The direction of gravity may be parallel to a height direction of the multifunctional ice beverage machine 1, and the height direction of the multifunctional ice beverage machine 1 may be represented by the straight line wherein the arrow Z is located in FIG. 1 and FIG. 2. The ice receiving basket 113 being configured as drawer-type basket and slidably inserted into the housing 10 refers to that the ice receiving basket 113 is capable of moving in and out of the housing 10 in a drawer-like manner. For example, the ice receiving basket 113 may be moved to the lower side of the first evaporator 111 along the direction of gravity via a rail-and-slider assembly to receive the ice cubes dropped from the grooves 112, or moved to an exterior of the housing 10 to facilitate a user to take the ice cubes in the ice receiving basket 113. More descriptions regarding the ice cube forming assembly 11 may be found in the related descriptions below.

The slush beverage forming assembly 12 includes a second evaporator 121. The slush beverage forming assembly 12 further includes a drive motor 123 and a scraper 122. The drive motor 123 is connected to the second evaporator 121 and drives the second evaporator 121 to roll about an axis of the second evaporator 121. The scraper 122 is disposed on a side wall of the second evaporator 121 to detach solidified ice crystals from the side wall of the second evaporator 121 to form a slush. The axis of the second evaporator 121 refers to a central axis of the second evaporator 121. For example, as shown in FIG. 2, the second evaporator 121 is shaped like a cylinder, and the axis of the second evaporator 121 is the rotational axis of the cylinder. The scraper 122 is in contact with the ice crystals on the side wall of the second evaporator 121, and when the second evaporator 121 rolls, the scraper 122 scrapes the ice crystals so that the ice crystals fall off the second evaporator 121 to form the slush. More descriptions regarding the slush beverage forming assembly 12 may be found in the related descriptions below.

The refrigeration assembly 13 includes a compressor 130 and a condenser 131. The compressor 130 is in fluid connection with the first evaporator 111 and the second evaporator 121 through the condenser 131. The compressor 130 refers to a structure for pressurizing and warming a refrigerant. For example, the compressor 130 may compress the refrigerant to form a high-temperature and high-pressure gaseous refrigerant. The condenser 131 refers to a structure for cooling down the refrigerant output by the compressor 130, and transforming the refrigerant from a gaseous state to a liquid state. The liquid refrigerant output by the condenser 131 is transported to the evaporator after being processed at a low temperature and a low pressure (e.g., after the liquid refrigerant passes through a capillary tube 141). The refrigerant refers to a medium that exchanges heat with the liquid on the surface of the evaporator in the evaporator. After entering the first evaporator 111, the refrigerant absorbs a large amount of heat from the surface of the first evaporator 111, causing the temperature of the surface of the first evaporator 111 to drop significantly below the freezing point, thereby freezing the liquid in the groove 112 into the ice cubes. After entering the second evaporator 121, the refrigerant absorbs a large amount of heat from a surface of the second evaporator 121, causing the temperature of the surface of the second evaporator 121 to drop significantly below the freezing point, thereby freezing the liquid on the surface of the second evaporator 121 into the ice crystals. More descriptions regarding the refrigeration assembly 13 may be found in the related descriptions below.

An interior of the housing 10 includes a first chamber 105, a second chamber 106, and a third chamber 107 adjacent to each other. The compressor 130 and the condenser 131 are disposed in the first chamber 105. The first evaporator 111 is disposed in the second chamber 106. The second evaporator 121 is disposed in the third chamber 107. The first chamber 105, the second chamber 106, and the third chamber 107 being adjacent to each other refers to that the first chamber 105, the second chamber 106, and the third chamber 107 are directly or indirectly connected. For example, the first chamber 105, the second chamber 106, and the third chamber 107 are respectively formed by different portions of the housing 10, and the different portions of the housing 10 are connected to each other. In some embodiments, along the direction of the straight line where the arrow X is located, the first chamber 105, the second chamber 106, and the third chamber 107 are arranged in sequence from left to right. The refrigeration assembly 13 (including the compressor 130 and the condenser 131) is disposed in the first chamber 105. The ice cube forming assembly 11 (including the first evaporator 111, the first water tank 114, the first water pump, and the ice receiving basket 113) is disposed in the second chamber 106. The slush beverage forming assembly 12 (including the second evaporator 121, the second water tank 124, the drive motor 123, the second water pump 125, and the scraper 122) is disposed in the third chamber 107. The design of three adjacent chambers can fully utilize the internal space of the housing 10, improve the miniaturization of the multifunctional ice beverage machine, avoid mutual interference among components, and improve work efficiency. More descriptions regarding the housing 10 may be found in the related descriptions below.

The ice cube forming assembly 11 and the slush beverage forming assembly 12 of the present disclosure share the same compressor 130 and the same condenser 131, and are integrated into the same housing 10, thereby achieving integrated and compact production of a variety of ice products (e.g., ice cubes and slushes), and expanding the application scenarios of the ice beverage machine. In addition, the same compressor 130 can be used to simultaneously produce various forms ice products, thereby enhancing beverage variety and preparation efficiency.

The present disclosure arranges the refrigeration assembly 13, the ice cube forming assembly 11, and the slush beverage forming assembly 12 in different adjacent chambers within the housing 10, so that functional modules are reasonably arranged to avoid mutual interference, further improving the compactness and practicality of the multifunctional ice beverage machine 1.

The present disclosure enables simultaneous production of ice cubes and slushes. The user can mix the ice cubes and the slush to form a new ice beverage. The slush mixed with the ice cubes is not easy to melt, and can make the ice beverage taste better.

It should be noted that the above embodiments are for illustrative purposes only, demonstrating how the integration of multiple ice product productions is achieved through the shared compressor 130 and the condenser 131 in the present disclosure. However, these embodiments do not limit the types or count of evaporators—additional evaporators may be incorporated to utilize the same compressor 130 and condenser 131 for producing different frozen beverages. For example, the multi-functional ice beverage machine 1 may further include a third evaporator, where the compressor 130 is connected to the third evaporator via the condenser 131. The third evaporator is configured to cool a liquid in a water tank (e.g., a third water tank housed in the housing 10, which is in direct contact with the third evaporator) near its surface to produce chilled water. As another example, the multi-functional ice beverage machine 1 may further include a fourth evaporator, a high-pressure homogenizer, and a mixer. The compressor 130 is in fluid communication with the fourth evaporator via the condenser 131. The high-pressure homogenizer is configured to homogenize ingredients (e.g., milk, water, emulsifiers, etc.) for ice cream production. The fourth evaporator is configured to solidify the homogenized mixture. The mixer then agitates the semi-solidified product to form ice cream. Through the coordinated operation of the fourth evaporator, the high-pressure homogenizer, and the mixer, the multi-functional ice beverage machine 1 can produce ice cream—a distinct frozen product compared to ice cubes, shaved ice, or chilled water—thereby expanding the variety of frozen products and enhancing the machine's application scenarios.

In some embodiments, a withdrawal direction of the ice receiving basket 113 (as shown by the straight line where the arrow Y is located in FIG. 2) is parallel to an axial direction of the second evaporator 121. For example, in the embodiment illustrated in FIG. 2, the housing 10 includes a first side wall 108 and a second side wall 109. The first side wall 108 and the second side wall 109 are disposed relative to each other along the straight line where the arrow Y is located. The first side wall 108 is provided with a first opening 1081, and the ice receiving basket 113 is capable of entering and exiting the housing 10 through the first opening 1081. The straight line where the arrow Y is located may be referred to as a width direction of the multifunctional ice beverage machine 1. By making the withdrawal direction of the ice receiving basket 113 parallel to the axial direction of the second evaporator 121, interference between the ice receiving basket 113 and the second evaporator 121 can be prevented, i.e., the ice receiving basket 113 may be pulled at any time regardless of whether the second evaporator 121 is working.

In some embodiments, as shown in FIG. 2, a depth direction of the grooves 112 on the surface of the first evaporator 111 is parallel to a horizontal direction. The depth direction of the grooves 112 refers to a direction perpendicular to end surfaces of openings of the grooves 112. The horizontal direction refers to a length direction of the multifunctional ice beverage machine 1. The horizontal direction is perpendicular to the height direction and the width direction of the multifunctional ice beverage machine 1. The horizontal direction can be indicated by the straight line where the arrow X in FIG. 1 and FIG. 2 is located. When the ice cubes formed in the grooves 112 exceed the openings of the grooves 112, the ice cubes may detach from the grooves 112 under a self-gravitational force or other effects (e.g., a mechanical vibration provided by a vibration head described below) and fall into the ice receiving basket 113. In some embodiments, as shown in FIG. 2, the openings of the grooves 112 are inclined toward the ice receiving basket 113. This design facilitates the ice cubes to detach from the grooves 112 after being formed.

In some embodiments, a side wall surface of the second evaporator 121 is a rough surface to enhance adhesion and solidification of a liquid (e.g., purified water, juice, yogurt, etc.). For example, a plurality of dot-shaped protrusions and/or recesses are evenly arranged on the surface of the second evaporator 121. As another example, a plurality of sawtooth-shaped or wave-shaped protrusions are arranged on the surface of the second evaporator 121.

In some embodiments, as shown in FIG. 1, the ice cube forming assembly 11 further includes a first water tank 114 and a first water pump 115. The first water pump 115 is connected to the first water tank 114 and configured to pump water within the first water tank 114 to the surface (e.g., within the grooves 112) of the first evaporator 111. The slush beverage forming assembly 12 further includes a second water tank 124 and a second water pump 125. The second water pump 125 is connected to the second water tank 124 and configured to pump water within the second water tank 124 to the surface of the second evaporator 121. The first water tank 114 is configured as a drawer-type structure and disposed in the second chamber 206, and the second water tank 124 is configured as a lift-and-pull type structure and disposed in the third chamber 207.

The drawer-type structure refers to that the first water tank 114 is capable of moving relative to the housing 10 in the drawer-like manner. For example, the first water tank 114 is capable of moving in and out of the second chamber 206 via a rail-and-slider assembly, facilitating the user to replenish a liquid into the first water tank 114. In some embodiments, a movement direction of the first water tank 114 may be parallel to the width direction of the multifunctional ice beverage machine 1. The lift-and-pull type structure refers to that the second water tank 124 is capable of moving relative to the housing 10 by lifting and pulling. For example, the second water tank 124 may be disposed on the housing 10 by a rail-and-slider assembly. The user may lift and pull the second water tank 124 to move the second water tank 124 in and out of the third chamber 107, facilitating the user to replenish a liquid into the second water tank 124. In some embodiments, a movement direction of the second water tank 124 may be parallel to the height direction of the multifunctional ice beverage machine 1.

In this embodiment, the first water tank 114 is pulled along a horizontal direction (the length direction of the multifunctional ice beverage machine 1), and the second water tank 124 is pulled along a vertical direction (the height direction of the multifunctional ice beverage machine 1). The first water tank 114 and the second water tank 124 move along different directions relative to the housing 10, which can further avoid mutual interference between the first water tank 114 and the second water tank 124.

In some embodiments, the first water tank 113 and the second water tank 124 are mutually independent and not in fluid connection. In some embodiments, the first water tank 114 and the second water tank 124 are respectively configured to store different types of liquids. For example, the first water tank 114 stores purified water, and the second water tank 124 stores juice or yogurt. It may be understood that the first water tank 114 may also store juice, yogurt, etc., and the second water tank 124 may also store purified water.

The embodiments of the present disclosure further improve the compactness and practicality of the multifunctional ice beverage machine 1 by reasonably arranging the functional modules to avoid mutual interference among the functional modules.

In some embodiments, as shown in FIG. 1, the refrigeration assembly 13 further includes a first refrigerant pipeline 1321, a second refrigerant pipeline 1322, a first return pipeline 133, and a second return pipeline 134.

The compressor 130 is in fluid connection with an inlet of the condenser 131, an outlet of the condenser 131 is in fluid connection with the first evaporator 111 through the first refrigerant pipeline 1321, and another outlet of the condenser 131 is in fluid connection with the second evaporator 121 through the second refrigerant pipeline 1322.

An outlet of the first evaporator 111 is in fluid connection with the compressor 130 through the first return pipeline 133, and an outlet of the second evaporator 121 is in fluid connection with the compressor 130 through the second return pipeline 134.

The first refrigerant pipeline 1321 refers to a pipeline through which the refrigerant flows from the condenser 131 to the first evaporator 111. The refrigerant is compressed by the compressor 130 and then enters the condenser 131. The refrigerant is condensed by the condenser 131 and then enters the first evaporator 111 through the first refrigerant pipeline 1321. The second refrigerant pipeline 1322 refers to a pipeline through which the refrigerant flows from the condenser 131 to the second evaporator 121. The refrigerant is compressed by the compressor 130 and then enters the condenser 131. The refrigerant is condensed by the condenser 131 and then enters the second evaporator 121 through the second refrigerant pipeline 1322. The first return pipeline 133 refers to a pipeline through which the refrigerant returns from the first evaporator 111 to the compressor 130. After absorbing heat near the first evaporator 111, the refrigerant returns to the compressor 130 through the first return pipeline 133, thereby realizing a refrigerant circulation between the compressor 130 and the first evaporator 111. The second return pipeline 134 refers to a pipeline through which the refrigerant returns from the second evaporator 121 to the compressor 130. After absorbing heat near the second evaporator 121, the refrigerant returns to the compressor 130 through the second return pipeline 134, thereby realizing a refrigerant circulation between the compressor 130 and the second evaporator 121.

In some embodiments, each of the first refrigerant pipeline 1321 and the second refrigerant pipeline 1322 is further provided with a drying filter 140 and a capillary tube 141. The drying filter 140 is located between the condenser 131 and the capillary tube 141.

The drying filter 140 refers to a structure for removing water molecules from the refrigerant and filtering impurities from the refrigerant. By providing the drying filter 140, it can prevent the water molecules from freezing into ice when flowing through the capillary tube 141, thereby avoiding blockage of the capillary tube 141. In addition, the drying filter 140 can prevent impurities in the refrigerant from clogging the narrow capillary tube 141. The capillary tube 141 refers to a structure for throttling the refrigerant. The refrigerant can be converted into a low-temperature and low-pressure state through a throttling effect of the capillary tube 141. When the low-temperature and low-pressure refrigerant enters the evaporator, the low-temperature and low-pressure refrigerant can absorb the heat near the evaporator, causing liquid on the surface of the evaporator to solidify.

In this embodiment, the compressor 130 compresses the refrigerant to form the high-temperature and high-pressure gaseous refrigerant. The high-temperature and high-pressure gaseous refrigerant passes through the condenser 131, the drying filter 140, and the capillary tube 141 and then enters the first evaporator 111 and/or the second evaporator. The refrigerant entering the evaporator expands and absorbs heat to achieve cooling. The expanded refrigerant returns to the compressor through the first return pipeline 133 and/or the second return pipeline 134, thereby forming a refrigerant circulation between the compressor 130 and the evaporator.

In some embodiments, the refrigeration assembly 13 further includes a first solenoid valve 135 and a second solenoid valve 136. The first solenoid valve 135 is disposed in the first refrigerant pipeline 1321 and configured to control the on-off of the first refrigerant pipeline 1321. The second solenoid valve 136 is disposed in the second refrigerant pipeline 1322 and configured to control the on-off of the second refrigerant pipeline 1322.

The first solenoid valve 135 refers to a valve for controlling opening/closing of the first refrigerant pipeline 1321. The second solenoid valve 136 is a valve for controlling opening/closing of the second refrigerant pipeline 1322. During ice cube production, the first solenoid valve 135 is opened. The refrigerant output by the condenser 131 enters the first evaporator 111 through the first refrigerant pipeline 1321. During slush production, the second solenoid valve 136 is opened. The refrigerant output by the condenser 131 enters the second evaporator 121 through the first refrigerant pipeline 1321. When making ice cubes and a slush at the same time, the first solenoid valve 135 and the second solenoid valve 136 are opened. The refrigerant output by the condenser 131 enters the first evaporator 111 and the second evaporator 121 through the first refrigerant pipeline 1321 and the second refrigerant pipeline 1322, respectively.

In this embodiment, by providing the first solenoid valve 135 and the second solenoid valve 136, the opening/closing of the first refrigerant pipeline 1321 and the second refrigerant pipeline 1322 can be controlled. The corresponding refrigerant pipeline can be selectively opened based on ice-making requirements of the user, thereby reducing energy consumption.

In some embodiments, the refrigeration assembly 13 further includes a first connecting pipeline 1371, a second connecting pipeline 1372, and a connecting solenoid valve 138. An inlet of the first connecting pipeline 1371 is in fluid connection with the compressor 130. An outlet of the first connecting pipeline 1371 is in fluid connection with the first evaporator 111. An inlet of the second connecting pipeline 1372 is in fluid connection with the inlet of the first connecting pipeline 1371. An outlet of the second connecting pipeline 1372 is in fluid connection with the second evaporator 121. The connecting solenoid valve 138 is provided between the inlet of the first connecting pipeline 1371 and the inlet of the second connecting pipeline 1372, to control the refrigerant in the compressor 130 to enter the first evaporator 111 and the second evaporator 121 through the first connecting pipeline 1371 and the second connecting pipeline 1372, respectively

The first connecting pipeline 1371 refers to a pipeline through which the refrigerant compressed by the compressor 130 directly enters the first evaporator 111. The second connecting pipeline 1372 refers to a pipe through which the refrigerant compressed by the compressor 130 directly enters the second evaporator 121. The connecting solenoid valve 138 refers to a valve for controlling the opening/closing of the first connecting pipeline 1371 and the second connecting pipeline 1372.

By providing the first connecting pipeline 1371, when the connecting solenoid valve 138 is opened and the first solenoid valve 135 is closed, the refrigerant compressed by the compressor 130 does not pass through the condenser 131 but directly enters the first evaporator 111 through the first connecting pipeline 1371. Since the refrigerant is not condensed by the condenser 131, the temperature of the refrigerant is relatively high, and the high-temperature refrigerant can raise the surface temperature of the first evaporator 111, facilitating de-icing of the first evaporator 111. The de-icing refers to separating the slush or the ice cubes from the evaporator after the slush or the ice cubes are formed. Similarly, by providing the second connecting pipeline 1372, when the connecting solenoid valve 138 is opened, and the second solenoid valve 136 is closed, the refrigerant compressed by the compressor 130 does not pass through the condenser 131 but directly enters the second evaporator 121 through the second connecting pipeline 1372, thereby facilitating de-ice and cleaning of the second evaporator 121.

In some embodiments, as shown in FIG. 1, the refrigeration assembly 13 further includes a radiator 139 configured to dissipate heat for an operation of the condenser 131. For example, the radiator 139 may be a fan.

In some embodiments, a slush making functional module (i.e., the slush beverage forming assembly 12) and an ice cube making functional module (i.e., the ice cube forming assembly 11) share the same compressor 130, the same condenser 131, and the same cooling fan.

In some embodiments, as shown in FIG. 1, the multifunctional ice beverage machine 1 further includes a power supply 15. The power supply 15 supplies power to the multifunctional ice beverage machine 1 during its entire working process. In some embodiments, the power supply 15 is disposed in the first chamber 105.

The multifunctional ice beverage machine 1 provided in the embodiments of the present disclosure realizes functions including slush making, ice cube making, de-icing, and cleaning.

When making a slush, the second solenoid valve 136 is opened, and the first solenoid valve 135 and the connecting solenoid valve 138 are closed. The refrigerant is compressed by the compressor 130. The compressed refrigerant is cooled and liquefied by the condenser 131. The liquefied refrigerant enters the second evaporator 121 through the second solenoid valve 136, the drying filter 140, and the capillary tube 141 (where the refrigerant is transformed to the low-temperature and low-pressure state). The refrigerant absorbs heat from the second evaporator 121, reduces the surface temperature of the second evaporator 121 to significantly below the freezing point, and returns to the compressor 130 through the second return pipeline 134. The liquid on the surface of the second evaporator 121 freezes and is then scraped by the scraper 122 to form the slush.

When making ice cubes, the first solenoid valve 135 is opened, and the second solenoid valve 136 and the connecting solenoid valve 138 are closed. The refrigerant is compressed by the compressor 130. The compressed refrigerant is cooled and liquefied by the condenser 131. The liquefied refrigerant enters the first evaporator 111 through the first solenoid valve 156, the drying filter 140, and the capillary tube 141 (where the refrigerant is transformed to the low-temperature and low-pressure state). The refrigerant absorbs heat from the first evaporator 111, reduces the surface temperature of the first evaporator 111 to significantly below the freezing point, and returns to the compressor 130 through the first return pipeline 133. The liquid within the grooves 112 of the first evaporator 111 freezes to form the ice cubes.

When making ice cubes and a slush at the same time, the first solenoid valve 135 and the second solenoid valve 136 are opened, and the connecting solenoid valve 138 is closed. After the refrigerant is compressed by the compressor 130, a portion of the refrigerant enters the first evaporator 111 through the condenser 131 and the first refrigerant pipeline 1321, and then returns to the compressor through the first return pipeline 133. Another portion of the refrigerant enters the second evaporator 121 through the condenser 131 and the second refrigerant pipeline 1322, and then returns to the compressor 130 through the second return pipeline 134.

When de-icing or cleaning, the first solenoid valve 135 and the second solenoid valve 136 are closed, and the connecting solenoid valve 138 is opened. After the refrigerant is compressed by the compressor 130, a portion of the high-temperature refrigerant directly enters the first evaporator 111 through the first connecting pipeline 1371, and another portion of the high-temperature refrigerant directly enters the second evaporator 121 through the second connecting pipeline 1372, thereby increasing the surface temperature of the first evaporator 111 and the second evaporator 121 to achieve ice melting and de-icing.

The multifunctional ice beverage machine 1 provided in the embodiment of the present disclosure can produce two kinds of ice products separately or simultaneously. Compared with conventional ice makers that require multiple coordinated devices to achieve similar functionality, the multifunctional ice beverage machine 1 offers greater operational versatility and broader application scenarios.

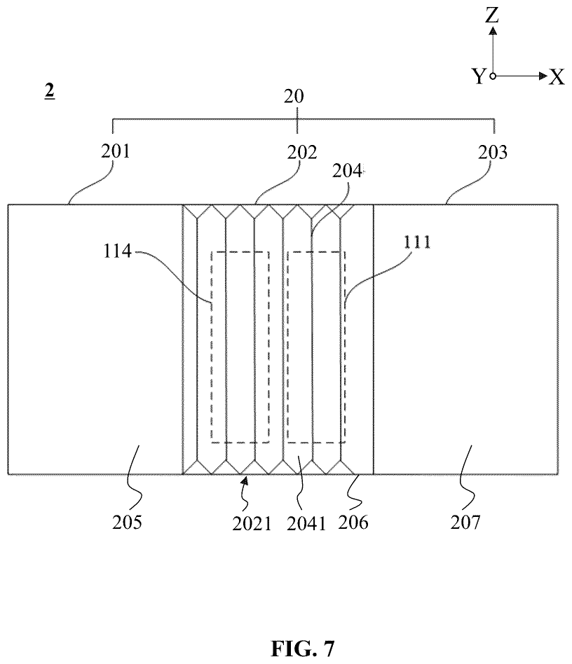

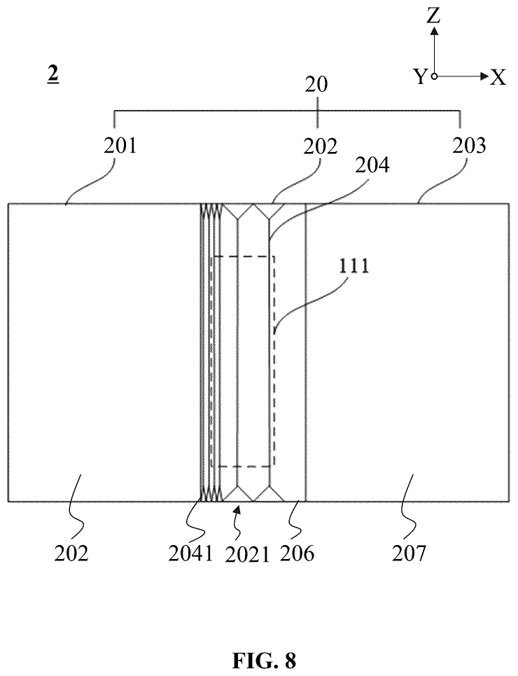

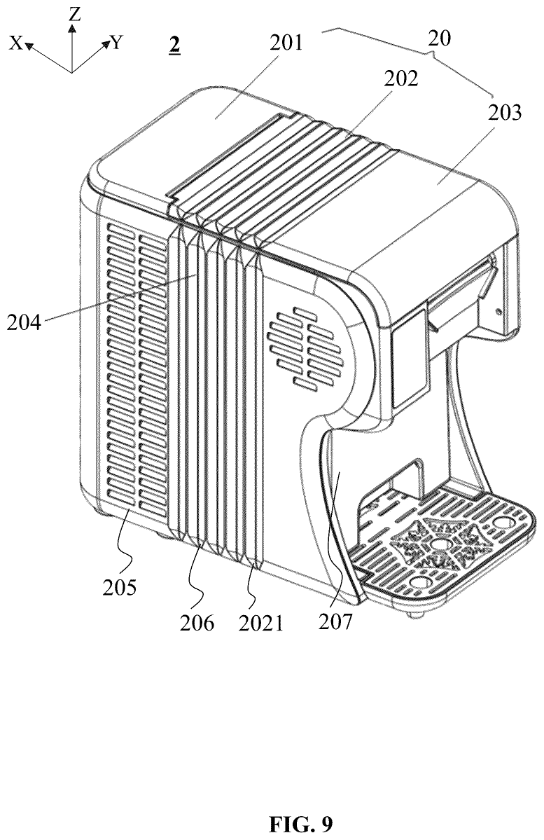

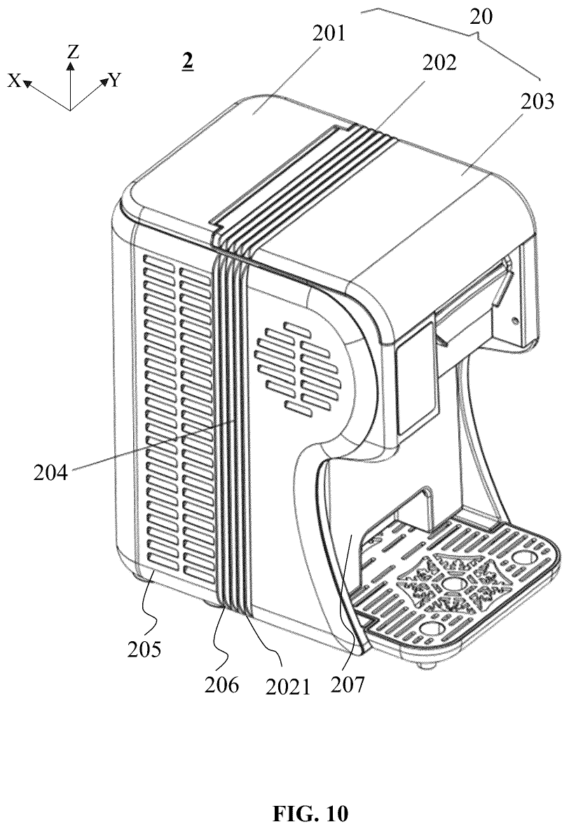

FIG. 7 is a schematic diagram illustrating a pre-folding configuration of a multifunctional ice beverage machine according to other embodiments of the present disclosure. FIG. 8 is a schematic diagram illustrating a post-folding configuration of the multifunctional ice beverage machine according to other embodiments of the present disclosure. FIG. 9 is a schematic diagram illustrating a structure of the multifunctional ice beverage machine before folding according to other embodiments of the present disclosure. FIG. 10 is a schematic diagram illustrating a structure of the multifunctional ice beverage machine after folding according to other embodiments of the present disclosure.

Some embodiments of the present disclosure further provides a multifunctional ice beverage machine 2. The structure of the multifunctional ice beverage machine 2 is similar to the structure of the multifunctional ice beverage machine 1. For example, structures of an ice cube forming assembly, a slush beverage forming assembly, and a refrigeration assembly of the multifunctional ice beverage machine 2 is the same as or similar to the structures of the ice cube forming assembly 11, the slush beverage forming assembly 12, and the refrigeration assembly 13 of the multifunctional ice beverage machine 1. More descriptions regarding the ice cube forming assembly 11, the slush beverage forming assembly 12, and the refrigeration assembly 13 may be found in the related descriptions above. The difference between the multifunctional ice beverage machine 2 and the multifunctional ice beverage machine 1 is that a housing 20 of the multifunctional ice beverage machine 2 is different from the housing 10 of the multifunctional ice beverage machine 1. As shown in FIG. 7 to FIG. 10, the housing 20 includes a first shell 201, a second shell 202, and a third shell 203 connected in sequence. A first chamber 205 is formed in the first shell 201, a second chamber 206 is formed in the second shell 202, and a third chamber 207 is formed in the third shell 203. Two sides of the second shell 202 are detachably connected to the first shell 201 and the third shell 203, respectively.

The first shell 201, the second shell 202, and the third shell 203 being connected in sequence refers to that the first shell 201, the second shell 202, and the third shell 203 are sequentially connected along a length direction of the multifunctional ice beverage machine 2. The length direction of the multifunctional ice beverage machine 2 may be indicated by the straight line where the arrow X is located in FIG. 7 to FIG. 10. The first shell 201, the second shell 202, and the third shell 203 are connected in sequence from left to right along the straight line where the arrow X is located. The two sides of the second shell 202 along the length direction of the multifunctional ice beverage machine 2 are detachably connected to the first shell 201 and the third shell 203, respectively. In some embodiments, the detachable connection may include a magnetic connection, a snap-slot connection, a threaded connection, or the like.

The second shell 202 is configured as a telescopic structure 2021. When the second shell 202 is in an extended state, the first water tank 114 is located in the second chamber 206, and the ice cube forming assembly 11 is in a connected state. When the second shell 202 is in a retracted state, the first water tank 114 is withdrawn from the second chamber 206 and the ice cube forming assembly 11 is in a disconnected and non-operational state.

The telescopic structure 2021 refers to a structure that is capable of changing its dimensions by extending or retracting. For example, the second shell 202 is capable of extending or retracting along the length direction of the multifunctional ice beverage machine 2, thereby changing a dimension of the second shell 202 in the length direction of the multifunctional ice beverage machine 2. In the embodiments illustrated in FIG. 7 and FIG. 9, the second shell 202 is in the extended state. In the embodiments illustrated in FIG. 8 and FIG. 10, the second shell 202 is in the retracted state. The ice cube forming assembly 11 being in the connected state refers that components (e.g., the first water tank 114, the first water pump 115, the first evaporator 111, etc.) of the ice cube forming assembly 11 are connected to each other, and the ice cube forming assembly 11 is capable of operating normally. The ice cube forming assembly 11 being in the disconnected and non-operational state refers to the components of the ice cube forming assembly 11 are not connected, and the ice cube forming assembly 11 is not operable.

In this embodiment, when the ice cube forming assembly 11 is in the extended state, the second chamber 206 is capable of accommodating the first water tank 114, and the ice cube forming assembly 11 is in the connected state. When the ice cube forming assembly 11 is in the retracted state, the second chamber 206 is not large enough to accommodate the first water tank 114. The first water tank 114 is separated from the second chamber 206, and the ice cube forming assembly 11 is in the disconnected and non-operational state.

The form of the telescopic structure 2021 is not limited by the present disclosure. Merely by way of example, the second shell 202 may be a flexible structure. For example, the second shell 202 is made of silicone or rubber and is capable of extending and retracting by flexible folding. As another example, the second shell 202 is a multi-section structure, and each section of the multi-section structure is connected by an elastic member (e.g., a spring, a telescopic rod, etc.) to achieve extension/retraction.

In some embodiments, at least a portion of the second shell 202 is a folding fan structure 204. As shown in FIG. 5 to FIG. 8, the folding fan structure 204 is capable of folding or unfolding under an external force. The second shell 202 is in the retracted state when the folding fan structure 204 is folded, and the second shell 202 is in the extended state when the folding fan structure 204 is unfolded. The folding fan structure 204 refers to a structure that is foldable in a manner similar to a folding fan. The folding fan structure 204 includes a plurality of folding plates 2041 arranged along the length direction of the multifunctional ice beverage machine 2, an adjacent folding plates 2041 among the plurality of folding plates 2041 foldable relative to each other. When the folding fan structure 204 is folded, the plurality of folding plates 2041 are capable of folding along the length direction of the multifunctional ice beverage machine 2, as shown in FIG. 6.

In some embodiments, the second shell 202 is provided with a first locking member and a second locking member. When the folding fan structure 204 is folded, the first locking member on the second shell 202 snaps onto the second locking member to lock the second shell 202 in the retracted state. For example, the first locking member may be a snap provided on a side of the second shell 202 near the first shell 201, and the second locking member may be a slot provided on a side of the second shell 202 near the third shell 203. After the second shell 202 is retracted, the locking is realized through the cooperation between the snap and the slot.

In this embodiment, the second shell 202 is configured as the telescopic structure 2021. This configuration facilitates the user to pull the first water tank 113 out of the second cavity 206 when the user does not need ice cubes. The outer shell 20 is retracted through the foldable second shell 202 to further reduce the overall size of the multifunctional ice beverage machine 2, so that the multifunctional ice beverage machine 2 is more compact and easy to carry, making the multifunctional ice beverage machine 2 suitable for more application scenarios. For example, the telescopic function of the second shell 202 is suitable for camping. The flexible accessibility of the first water tank 114 combined with the telescopic function of the second shell 202 makes the multifunctional ice beverage machine 2 more compact while maintaining slush making functions, facilitating convenient transportation between camping sites.

In some embodiments, the multifunctional ice beverage machine (e.g., the multifunctional ice beverage machine 1 and the multifunctional ice beverage machine 2) further includes a processor 17. The processor 17 may be in communication connection with components such as the ice cube forming assembly 11, the slush beverage forming assembly 12, and the refrigeration assembly 13.

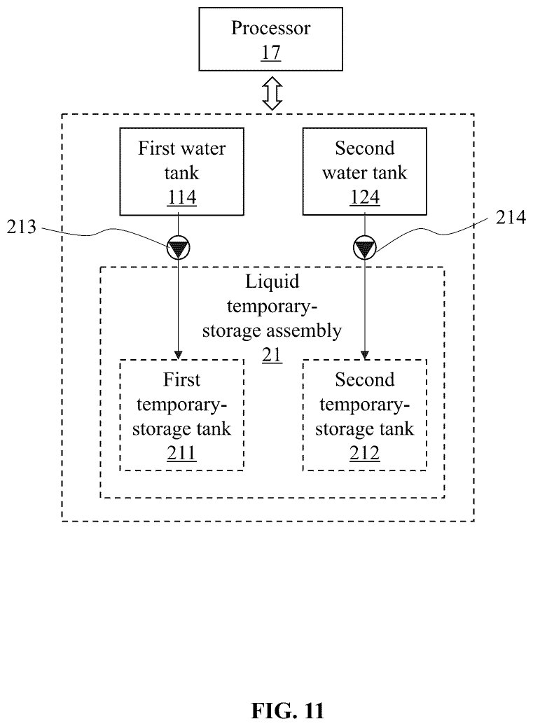

FIG. 11 is a schematic diagram illustrating a cooperation between a water tank and a liquid temporary-storage assembly according to some embodiments of the present disclosure. In some embodiments, as shown in FIG. 1 to FIG. 11, the multifunctional ice beverage machine (e.g., the multifunctional ice beverage machine 1 and the multifunctional ice beverage machine 2) may further include a liquid temporary-storage assembly 21. The liquid temporary-storage assembly 21 includes a first temporary-storage tank 211 and/or a second temporary-storage tank 212. The first temporary-storage tank 211 is configured to store a portion of a liquid within the first water tank 114, and a distance between the first temporary-storage tank 211 and the first evaporator 111 is less than a first preset distance. The second temporary-storage tank 212 is configured to store a portion of a liquid within the second water tank 124, and a distance between the second temporary-storage tank 212 and the second evaporator 121 is less than a second preset distance.

In some embodiments, the first temporary-storage tank 211 is a tank with a storage space. The liquid within the first water tank 114 may be pumped to the first temporary-storage tank 211 by a first temporary-storage pump 213. The liquid within the first temporary-storage tank 211 may be pumped to the surface of the first evaporator 111 (e.g., the surfaces of the grooves 112) by a water pump. The structure of the first temporary-storage tank 211 may be similar to the structure of the first water tank 114, but the size of the first temporary-storage tank 211 is smaller than the size of the first water tank 114. The distance between the first temporary-storage tank 211 and the first evaporator 111 refers to a shortest distance between the first temporary-storage tank 211 and the first evaporator 111 (e.g., the grooves 112). The first preset distance may be less than or equal to 5 cm. In some embodiments, the first temporary-storage tank 211 may be in direct contact with the first evaporator 111 (e.g., the first temporary-storage tank 211 may be in contact with the grooves 112). The second temporary-storage tank 212 is the same or similar to the first temporary-storage tank 211.

The multifunctional ice beverage machine needs to be prepared in advance before preparing an ice beverage. For example, the refrigerant needs to be first compressed by the compressor 130 and then transported through the condenser and the corresponding refrigerant pipelines to the corresponding evaporator, so that the surface temperature of the corresponding evaporator is reduced to a temperature significantly below the freezing point.

In this embodiment, by providing the liquid temporary-storage assembly 21, the excess cold energy emitted by the evaporator can be used to pre-cool the liquid within the liquid temporary-storage assembly 21 during preparatory procedures of the multifunctional ice beverage machine, thereby improving ice-making efficiency and reducing energy waste.

In some embodiments, the liquid temporary-storage assembly 21 further includes a first temporary-storage pump 213 and a second temporary-storage pump 214. The first temporary-storage pump 213 and the second temporary-storage pump 214 are in communication connection with the processor 17. The processor 17 is configured to: obtain a historical liquid type, a historical ice-making type and a historical ice-making count, and a historical ice-making time, and determine a future ice-making type and a future ice-making count during a future period; determine a first injection volume and a second injection volume based on the future ice-making type and the future ice-making count during the future period; control the first temporary-storage pump 213 to pump a liquid to the first temporary-storage tank 211 based on the first injection volume; and control the second temporary-storage pump 214 to pump a liquid to the second temporary-storage tank 212 based on the second injection volume.

The historical liquid type refers to a type of liquid (e.g., milk, purified water, etc.) within the first water tank 114 and the second water tank 124 during a preset period. The historical liquid type may be set based on a user input. The historical ice-making type and the historical ice-making count refer to a type and a count of an ice product produced by the user using the multifunctional ice beverage machine during the preset period. The ice product may include ice cubes and a slush. The historical ice-making time refers to a time point (e.g., a date and a moment) when the user uses the multifunctional ice beverage machine to make the ice product during the preset period.

In some embodiments, the preset period may be set based on a user input or a default value of the processor 17. In some embodiments, the processor 17 may obtain the historical liquid type, the historical ice-making type and the historical ice-making count, and the historical ice-making time based on the user input. For example, the user determines an ice-making type and an ice-making count of the ice product to be produced through a display screen 18 with an interactive function. The processor 17 may record a user instruction and obtain the liquid type, the ice-making type and the ice-making count, and the ice-making time from the user instruction as historical data.

The future ice-making type and the future ice-making count during the future period refers to a type and a count of the ice product that may be produced by the user using the multifunctional ice beverage machine during the future period. In some embodiments, the future period may be set based on a user input or a default value set by the processor 17.

In some embodiments, the processor 17 may add up a total count of servings of ice cubes and a total count of servings of slushes made during the future period based on the historical liquid type, the historical ice-making type, the historical ice-making count, and the historical ice-making time, and estimate a count of servings of ice cubes and a count of servings of slushes made per unit time. The processor 17 may determine the future ice-making type and the future ice-making count during the future period based on the count of servings of ice cubes and the count of servings of slushes made per unit time.

The per unit time may be set based on a user input or a default value set by the processor 17. The per unit time may be 1 day. For example, the user made one serving of ice cubes on the first 23 days of the past 30 days, and made two servings of ice cubes and slushes on the 7th day. The processor 17 determines that the total count of servings of ice cubes during the 30 days is 25 (23+2), and the total count of servings of slushes is 2. The processor 17 estimates that the count of servings of ice cubes per day is 5/6(=25/30 ), which is rounded up to 1. The processor 17 estimates that the count of servings of slushes per day is 1/15(=2/30 ), which is rounded down to 0. Therefore, the processor determines that one serving of ice cubes may be made during the future period (e.g., within 12 hours).

In some embodiments, the processor 17 may determine the future ice-making type and the future ice-making count during the future period by weighting processing based on the historical liquid type, the historical ice-making type, the historical ice-making count, and the historical ice-making time. For example, the processor 17 may determine the future ice-making type and the future ice-making count during the future period based on the following equation:

The future ice-making type and the future ice-making count during the future period=Σ[exp(1−Δtₖ)×Q_{k]}

In the above equation, Δtₖ denotes a time interval (in unit of days) between a timestamp when a k-th piece of historical data is recorded (e.g., a timestamp when a k-th historical liquid type is recorded) and a current timestamp. Qₖ denotes a historical ice-making type and a historical ice-making count in the k-th piece of historical data. exp (1−Δtₖ) denotes a weight coefficient, where k=1, 2, . . . , N (N denotes a total count of records of a type of historical data during the preset period, e.g., the historical data includes N records of historical liquid types). The weight coefficient is negatively correlated with the time interval Δtₖ, i.e., the closer a historical data record is to the current timestamp, the higher the weight coefficient of the historical data record is.

The first injection volume and the second injection volume refer to liquid volumes that meet the requirements for the future ice-making type and the future ice-making count during the future period. The processor 17 may determine the count of servings of ice cubes and the count of servings of slushes during the future period based on the future ice-making type and the future ice-making count during the future period, and then determine the first injection volume and the second injection volume based on the liquid volume required for making each serving of ice cubes and liquid volume required for making each serving of slushes. In some embodiments, the processor 17 may monitor the liquid volume of a liquid pumped by the temporary-storage pump through a flow sensor provided on the temporary-storage pump, thereby achieving accurate pumping of the liquid.

In this embodiment, adjusting the liquid volume of the liquid injected into the temporary-storage tank based on the ice-making type and the ice-making count can shorten the ice-making duration and improve user experience.

In some embodiments, the multifunctional ice beverage machine further includes a display screen 18. The display screen 18 is in communication connection with the processor 17. The processor 17 is further configured to: determine a waiting time and transmit the waiting time to the display screen 18. The display screen 18 is configured to display at least the waiting time.

The waiting time refers to a remaining waiting time for a current ice-making process. The waiting time may include an ice cube waiting time and/or a slush waiting time. In some embodiments, the display screen 18 is provided on a surface of a housing (e.g., the housing 10 or the housing 20).

In some embodiments, the processor 17 is further configured to: generate an estimated waiting time based on a liquid temperature and a liquid type within a water tank (e.g., the first water tank 114 and/or the second water tank 124) and the liquid temporary-storage assembly 21 (e.g., the first temporary-storage tank 211 and/or the second temporary-storage tank 212), and an ice-making type, designate the estimated waiting time as an initial waiting time, and transmit the estimated waiting time to the display screen 18 for display.

In some embodiments, the liquid type further includes liquid quality information. The liquid quality information refers to total dissolved solids (TDS) in the liquid or a liquid conductivity. In some embodiments, the liquid quality information may be detected and obtained by sensors (e.g., TDS sensors) provided in the tank (e.g., the first water tank 114 and/or the second water tank 124) and the liquid temporary-storage assembly 21 (e.g., the first temporary-storage tank 2112 and/or the second temporary-storage tank 212). In some embodiments, the liquid temperature may be detected and obtained by temperature sensors provided in the water tank and the liquid temporary-storage assembly 21.

In some embodiments, the estimated waiting time may be a time range, for example, the estimated waiting time is 45 seconds to 67 seconds.

In some embodiments, the display screen 18 is further configured to display a remaining liquid volume, a remaining producible count of ice products, etc. In some embodiments, the processor 17 may obtain the remaining liquid volume through liquid level sensors disposed in the water tank (e.g., the first water tank 114 and/or the second water tank 124) and the liquid temporary-storage assembly 21 (e.g., the first temporary-storage tank 211 and/or the second temporary-storage tank 212).

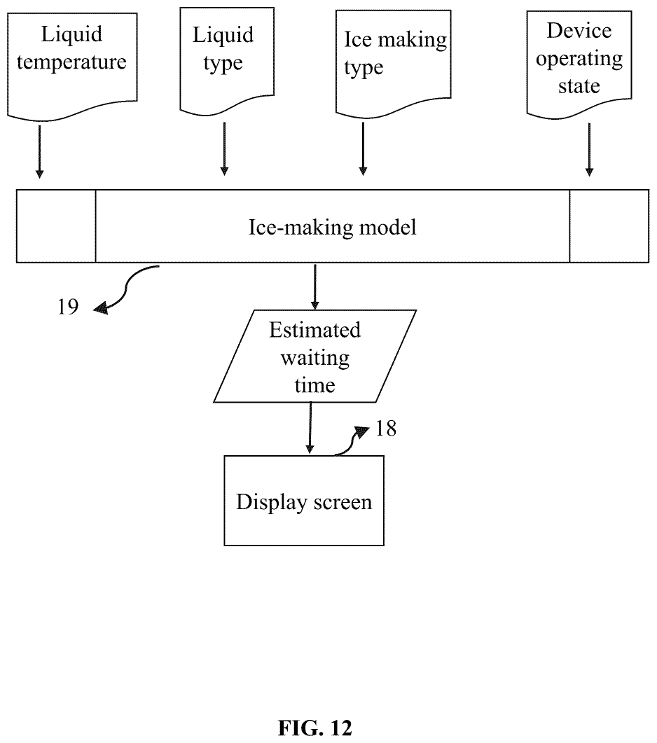

FIG. 12 is a schematic diagram illustrating an exemplary structure of an ice-making model according to some embodiments of the present disclosure

In some embodiments, as shown in FIG. 12, the processor 17 is configured to: generate an estimated waiting time via an ice-making model 19 based on a liquid temperature and a liquid type of a liquid within a water tank (e.g., the first water tank 114 and/or the second water tank 124) and the liquid temporary-storage assembly 21 (e.g., the first temporary-storage tank 211 and/or the second temporary-storage tank 212), an ice-making type, and a device operating state.

The device operating state refers to an operating state of a multifunctional ice beverage machine. The device operation state may include whether the multifunctional ice beverage machine is in a cold-start state, a cumulative startup count, a cumulative production count, or the like.

The cold-start state refers to a startup state requiring an extended preparation time to reach an ice-making condition. In some embodiments, the processor 17 may determine a period between a last startup and a current startup of the multifunctional ice beverage machine. If the period is greater than a first predetermined period, the processor 17 determines that the multifunctional ice beverage machine is in the cold-start state. If the period is less than or equal to the first predetermined period, the processor 17 determines that the multifunctional ice beverage machine is in a non-cold-start state. If the multifunctional ice beverage machine is in the cold-start state, it takes a relatively long time to complete an ice-making process. If the multifunctional ice beverage machine is in the non-cold-start state, it takes a relatively short time to complete the ice-making process. In some embodiments, the first predetermined period may be set based on a user input or a default value set by the processor 17.

The cumulative startup count refers to a count of startups of the multifunctional ice beverage machine within a second predetermined period. The second predetermined period may be set by the user input or be a default value of the processor 17.

Inputs of the ice-making model 19 are the liquid temperature and the liquid type of the liquid within the water tank (e.g., the first water tank 114 and/or the second water tank 124) and the liquid temporary-storage assembly 21 (e.g., the first temporary-storage tank 211 and/or the second temporary-storage tank 212), the ice-making type, and the device operating state, and an output of the ice-making model 19 is the estimated waiting time.

In some embodiments, the ice-making model 19 may be a deep learning model such as a convolutional neural network (CNN), a recurrent neural network (RNN), a long short-term memory (LSTM) network, etc.

The ice-making model 19 may be obtained by training based on at least one set of first training samples and first labels corresponding to the at least one set of first training samples. In some embodiments, the first training samples may include at least one set of parameters under different experimental conditions. The at least one set of parameters include sample liquid temperatures and sample liquid types of sample liquids within different water tanks and liquid temporary-storage assemblies, sample ice-making types, and sample device operating states. The different experimental conditions include liquid temperatures and liquid types within the different water tanks (e.g., the first water tank 114 and/or the second water tank 124) and the different liquid temporary-storage assemblies (e.g., the first temporary-storage tank 211 and/or the second temporary-storage tank 212), ice-making types, and different device operating states. The first label of a set of first training samples may be a waiting time for completing the making of a serving of an ice product under the experimental condition corresponding to the set of first training samples.

During training, the first training samples are input into an initial ice-making model, a loss function is constructed based on an output of the initial ice-making model and the first labels, and parameters of the initial ice-making model are iteratively updated (e.g., using a gradient descent manner) based on the loss function. The training is completed when a preset training condition is met, and a trained ice-making model is obtained. The trained ice-making model is designated as the ice-making model 19. The preset training condition may include, but is not limited to, the loss function converging, a count of training iterations reaching a threshold, or the like.

In this embodiment, by establishing the ice-making model 19, a more realistic estimated waiting time can be determined, thereby reducing error rates. By accurately estimating the time a user needs to wait, it facilitates better time management for the user.

In some embodiments, the processor 17 is further configured to: construct candidate production vectors based on historical liquid temperatures and historical liquid types within the water tank (e.g., the first water tank 114 and/or the second water tank 124) and the liquid temporary-storage assembly 21 (e.g., the first temporary-storage tank 211 and/or the second temporary-storage tank 212), historical ice-making types, historical device operating states, and historical waiting times, and establish a vector database; retrieve the vector database to determine candidate production vectors that satisfy a screening condition (the vector distance is the smallest or less than a preset vector threshold, etc.) based on the liquid temperature and the liquid type within the tank and the liquid temporary-storage assembly 21, the ice-making type, and the device operating state; determine a target production vector among the candidate production vectors that meets the screening condition, and designate the historical waiting time (e.g., a historical waiting time range) corresponding to the target production vector as the estimated waiting time.

In some embodiments, the multifunctional ice beverage machine further includes an ice product temporary-storage assembly 22 (see FIG. 5). The ice product temporary-storage assembly 22 includes an ice cube temporary-storage tank 221 and a slush temporary-storage tank 222. The ice cube temporary-storage tank 221 is configured to selectively receive ice cubes pre-produced by the first evaporator 111. The slush temporary-storage tank 222 is configured to selectively receive a slush pre-produced by the second evaporator 121.

The ice cube temporary-storage tank 221 and the slush temporary-storage tank 222 may be tanks with a storage space. The ice cube temporary-storage tank 221 may be the same as or similar to the first temporary-storage tank 211. The slush temporary-storage tank 222 may be the same or similar to the second temporary-storage tank 212. The term “selective receive” refers to that the temporary-storage device is capable of switching between receiving and not receiving the ice product. For example, the ice cube temporary-storage tank 221 is rotatably disposed below the direction of gravity of the first evaporator 111. When the ice cube temporary-storage tank 221 rotates to an angle such that its opening faces the first evaporator 111, the ice cube temporary-storage tank 221 is capable of receiving the ice cubes detached from the first evaporator 111. When the ice cube temporary-storage tank 221 rotates to another angle, the ice cubes detached from the first evaporator 111 cannot enter the ice cube temporary-storage tank 221. The working principle of the slush temporary-storage tank 222 is the same as or similar to the working principle of the ice cube temporary-storage tank 221. The processor 17 may control the rotation of the ice cube temporary-storage tank 221 and the slush temporary-storage tank 222.

In some embodiments, processor 17 is configured to: obtain a historical liquid type, a historical ice-making type, a historical ice-making count, and a historical ice-making time; and determine a pre-produced count of ice products (e.g., ice cubes and slushes) based on the historical liquid type, the historical ice-making type, the historical ice-making count, and the historical ice-making time.

The pre-produced count refers to a count of servings of ice products pre-produced by the multifunctional ice beverage machine.

In some embodiments, the processor 17 may determine the future ice-making type and the future ice-making count during the future period based on the historical liquid type, the historical ice-making type, the historical ice-making count, and the historical ice-making time; and determine the pre-produced count of ice products based on the future ice-making type and the future ice-making count during the future period. For example, the processor 17 may determine a count of servings of ice cubes and a count of servings of slushes based on the future ice-making type and the future ice-making count during the future period, and determine a pre-produced count of the ice cubes and a pre-produced count of the slushes.

More descriptions regarding the historical liquid type, the historical ice-making type, the historical ice-making count, and the historical ice-making time, and the determination of the ice-making type and the ice-making count during the future period may be found in the related descriptions above.

In some embodiments, the processor 17 is further configured to: obtain a current temporary-storage count of ice products. In response to determining that the current temporary-storage count of ice products is less than the pre-produced count, the processor 17 determines that the pre-production of the ice product continues. In response to determining that the current temporary-storage count of ice products is greater than or equal to the pre-produced count, the processor 17 determines that the pre-production of the ice product stops.

The current temporary-storage count of ice products refers to a weight of the ice products stored in the ice product temporary-storage assembly 22 at a current moment. In some embodiments, the current temporary-storage count may be detected and obtained by weight sensors provided at bottom portions of the ice cube temporary-storage tank 221 and the slush temporary-storage tank 222. In some embodiments, the current temporary-storage count of ice products may be greater than, less than, or equal to the pre-produced count.

In some embodiments, the multifunctional ice beverage machine further includes a first vibration head 161 and a second vibration head 162. The first vibration head 161 and the second vibration head 162 are connected to the first vibration head 111 and the second evaporator 121, respectively. The processor is configured to be communicatively connected to vibration motors of the first vibration head 161 and the second vibration head 162 to control the first vibration head 161 and the second vibration head 162 to vibrate.

Providing the vibration heads can achieve at least the following beneficial effects. Firstly, it is possible to dislodge ice crystals solidified on the surface of the first evaporator 111 promptly and improve production efficiency. Secondly, it is possible to prevent excessive accumulation of ice crystals solidified on the surface of the second evaporator 121, which may hinder the relative movement between the scraper 122 and the second evaporator 121. Thirdly, it is possible to eliminate residual ice crystals during liquid replacement, thereby ensuring clean evaporator surfaces.

In some embodiments, the processor 17 is further configured to: obtain an incremental count of ice products (e.g., the ice cubes and the slush) within the ice product temporary-storage assembly 22; and, in response to determining that the incremental count is less than a preset incremental count, control the first vibration head 161 and/or the second vibration head 162 to vibrate.

The incremental count of ice products refers to an increase of the weight of the ice products within a third predetermined period. The incremental count may include an ice cube incremental count and a slush incremental count. The third predetermined period may be set based on a user input or a default value set by the processor 17. In some embodiments, the incremental count of ice products may be detected and obtained by a weight sensor provided at a bottom portion of the ice product temporary-storage assembly 22. In some embodiments, the preset incremental count may be determined based on experience or may be a default value set by the processor 17. For example, the preset incremental count may be the weight corresponding to one serving of ice cubes or slush.

It should be understood that there exist known situations: the incremental count of ice products is not less than the preset incremental count, and the incremental count of ice products is less than the preset incremental count. In response to determining that the incremental count of ice products is less than the preset incremental count, the processor 17 may determine that the ice products are adhered to the evaporator, and control the vibration head to vibrate to make the ice products easier to fall off.

In some embodiments, in response to determining that the incremental count of ice products is less than the preset incremental count, the processor 17 controls the first vibration head 161 and/or the second vibration head 162 to vibrate, including: in response to determining that the ice cube incremental count is less than a preset ice cube incremental count, the processor 17 controls the first vibration head 161 to vibrate; in response to determining that the slush incremental count is less than a preset slush incremental count, the processor 17 controls the second vibration head 162 to vibrate.

In some embodiments, the first vibration head 161/ or the second vibration head 162 performs a single-point vibration or continuous vibrations to adapt to different scenarios. The single-point vibration refers to that the vibration head performs a one-time vibration. The continuous vibrations refer to that the vibrating head that performs multiple vibrations (e.g., 10 vibrations) continuously within a set period (e.g., within 2 seconds). The single-point vibration may provide a powerful impact, helping the ice cubes overcome the adhesion with the surface of the first evaporator 111 (e.g., the surfaces of the grooves 112), so that the ice cubes can be completely detached. The continuous vibrations may be performed when the single-point vibration is ineffective. The continuous vibrations prevent the ice crystals from excessively accumulating in corners that are difficult for the scraper to reach. Particularly, when changing the liquid type, the continuous vibrations prevent mixing of ice crystals from different liquids that may affect the taste of the slush.

Merely by way of example, if an ice cube incremental count after a first vibration is still less than the preset ice cube incremental count, the processor 17 increases a vibration intensity of the first vibration head 161. If an ice cube incremental count after a second vibration is still less than the preset ice cube incremental count, the processor 17 increases the vibration intensity of the first vibration head 161 and switches to the continuous vibrations.

In this embodiment, the vibrating head is controlled based on the incremental count of ice products, significantly reducing unnecessary noise and energy consumption. The vibration is performed when necessary to help the ice products separate from the evaporator, thereby balancing efficiency and intensity, and extending the service life of the multifunctional ice beverage machine.

In some embodiments, the processor 17 is further configured to: obtain a current and a torque of the drive motor 123; determine a vibration parameter of the second vibration head 162 based on the current and the torque of the drive motor 123; and control the second vibration head 162 to perform vibration based on the vibration parameter of the second vibration head 162.

In some embodiments, the processor 17 may detect and obtain the current of the drive motor 123 by a current sensor (e.g., a Hall effect sensor), and detect and obtain the torque of the drive motor 123 by a torque sensor (e.g., a magnetoelastic torque sensor).

The vibration parameter refers to a parameter related to a mechanical vibration generated by the vibration head. The vibration parameter may include a vibration intensity, a vibration frequency, or the like. The vibration frequency refers to a count of vibrations performed by the vibration head per unit of time (e.g., 1 second).

Merely by way of example, when a small amount of ice crystals accumulates on the surface of the second evaporator 121, the second vibration head 162 vibrates at a relatively low frequency and a relatively low intensity, thereby preventing the drive motor 123 from being overloaded or damaged, and enabling smoother scraping by the scraper 122. When a large amount of ice crystals accumulates on the surface of the second evaporator 121, the processor 17 may increase the vibration frequency and the vibration intensity of the second vibration head 162 to prevent the current and the torque of the drive motor 123 from being too high. When the liquid type within the second water tank 124 needs to be changed, the processor 17 may further increase the vibration frequency and the vibration intensity of the second vibration head 162 to prevent residual ice crystals on the surface of the second evaporator 121.

In this embodiment, the vibration parameter of the second vibration head 152 is determined by the current and the torque of the drive motor 123, and an active protection mechanism of the motor can be established to prevent the drive motor 123 from being overloaded or damaged, ensure smooth discharging, and prevent mixing of different types of slushes when changing the liquid type.

In some embodiments, the processor 17 is further configured to: obtain an environment temperature, a liquid temperature and a liquid type within a water tank (e.g., the first water tank 114 and/or the second water tank 124) and a liquid temporary-storage assembly 21 (e.g., the first temporary-storage tank 211 and/or the second temporary-storage tank 212); determine an advanced closing time based on the environment temperature, the liquid temperature and the liquid type within the water tank and the liquid temporary-storage assembly 21; and close the first solenoid valve 135 and/or the second solenoid valve 136 based on the advanced closing time.

The environment temperature may be detected and obtained by a temperature sensor provided on a housing (e.g., the housing 10 and the housing 20). The advanced closing time refers to a deviation between a de-icing time point and a solenoid valve closing time point, i.e., the solenoid valve is closed before de-icing is performed. After the solenoid valve is closed, the refrigeration assembly 13 stops supplying a cooling capacity to the evaporator, and the evaporator freezes the liquid through a remaining cooling capacity.

In this embodiment, by closing the first solenoid valve 135 and/or the second solenoid valve 136 in advance, the supply of the cooling capacity to the evaporator can be cut off before the de-icing is performed, which prevents continuous drop of the surface temperature of the evaporator, thereby reducing the strength of the slush or the ice cubes adhering to the evaporator and facilitating subsequent de-icing.

In some embodiments, the processor 17 is further configured to: obtain the incremental count of ice products within the ice product temporary-storage assembly 22 and an initial waiting time; determine a count of times that the incremental count of ice products is less than the preset incremental count; determine the advanced closing time based on the count of times that the incremental count of ice products is less than the preset incremental count and the initial waiting time. More descriptions regarding the incremental count of ice products, the preset incremental count, and the initial waiting time may be found in the related descriptions below.

Merely by way of example, the processor 17 may designate the initial waiting time as the advanced closing time and close the solenoid valves (e.g., the first solenoid valve 135 and the second solenoid valve 136) after the initial waiting time. During the production of the ice products, when the processor 17 determines that the incremental count of ice products is less than the preset incremental count (e.g., the processor 17 may make this determination every 10 seconds), it indicates that the adhesion between the ice products and the evaporator is strong. The processor 17 adjusts the advanced closing time to the initial waiting time multiplied by a first adjustment factor (the first adjustment factor is a user-preset value or a default value set by the processor 17, e.g., the first adjustment factor may be 0.95). The processor 17 may repeat this determination process until the incremental count of ice products is greater than or equal to the preset incremental count.

In some embodiments of the present disclosure, by adjusting the advanced closing time based on the initial waiting time, ice production efficiency can be improved to prevent untimely detachment of slushes or ice cubes or mixing of different types of slushes.

The preferred embodiments of the present disclosure are described in detail above. Modifications and variations can be made by those skilled in the art without creative labor based on the ideas of the present disclosure. Therefore, any technical solution that can be obtained by logical analysis, reasoning, or limited experimentation by those skilled in the art because of the prior art according to the idea of the present disclosure shall be within the scope of protection as determined by the claims. The scope of protection is determined by the claims.

What is claimed is:

1. A multifunctional ice beverage machine, comprising a housing, an ice cube forming assembly, a slush beverage forming assembly, and a refrigeration assembly, wherein
the ice cube forming assembly includes a first evaporator and an ice receiving basket,
a surface of the first evaporator is provided with grid-like grooves,
the ice receiving basket is located on a lower side of the first evaporator along a gravity direction,
the ice receiving basket is configured as a drawer-type basket and slidably inserted into the housing;
the slush beverage forming assembly includes a second evaporator, a drive motor, and a scraper,
the drive motor is connected to the second evaporator and drives the second evaporator to roll about an axis of the second evaporator,
the scraper is disposed on a side wall of the second evaporator to detach a solidified ice beverage from the side wall of the second evaporator to form a slush;
the refrigeration assembly includes a compressor and a condenser, the compressor is in fluid connection with the first evaporator and the second evaporator through the condenser; and
an interior of the housing includes a first chamber, a second chamber, and a third chamber adjacent to each other,
the compressor and the condenser are disposed in the first chamber,
the first evaporator is disposed in the second chamber, and
the second evaporator is disposed in the third chamber.

2. The multifunctional ice beverage machine of claim 1, wherein the ice cube forming assembly further includes a first water tank and a first water pump, the first water pump is connected to the first water tank and configured to draw water from the first water tank water to the surface of the first evaporator;
the slush beverage forming assembly further includes a second water tank and a second water pump, the second water pump is connected to the second water tank and configured to pump water from the second water tank to a surface of the second evaporator; wherein the first water tank is configured as a drawer-type structure and disposed in the second chamber, and the second water tank is configured as a lift-and-pull type structure and disposed in the third chamber.

3. The multifunctional ice beverage machine of claim 2, wherein the housing includes a first shell, a second shell, and a third shell connected in sequence; the first chamber is formed in the first shell, the second chamber is formed in the second shell, and the third chamber formed is formed in the third shell; two sides of the second shell are detachably connected to the first shell and the third shell, respectively; wherein
the second shell is configured as a telescopic structure,
when the second shell is in an extended state, the first water tank is located in the second chamber, and the ice cube forming assembly is in a connected state, and when the second shell is in a retracted state, the first water tank is withdrawn from the second chamber, and the ice cube forming assembly is in a disconnected and non-operational state.

4. The multifunctional ice beverage machine of claim 3, wherein at least a portion of the second shell is a folding fan structure, and the folding fan structure is capable of folding or unfolding under an external force,
the second shell is in the contracted state when the folding fan structure is folded, and
the second shell is in the extended state when the folding fan structure is unfolded.

5. The multifunctional ice beverage machine of claim 1, wherein the refrigeration assembly further includes a first refrigerant pipeline, a second refrigerant pipeline, a first return pipeline, and a second return pipeline;
the compressor is in fluid connection with an inlet of the condenser, an outlet of the condenser is in fluid connection with the first evaporator through the first refrigerant pipeline, and another outlet of the condenser is in fluid connection with the second evaporator through the second refrigerant pipeline; and
an outlet of the first evaporator is in fluid connection with the compressor through the first return pipeline, and an outlet of the second evaporator is in fluid connection with the compressor through the second return pipeline.

6. The multifunctional ice beverage machine of claim 5, wherein the refrigeration assembly further includes a first solenoid valve and a second solenoid valve;
the first solenoid valve is disposed in the first refrigerant pipeline and the second solenoid valve is disposed in the second refrigerant pipeline.

7. The multifunctional ice beverage machine of claim 5, wherein the refrigeration assembly further includes a first connecting pipeline, a second connecting pipeline, and a connecting solenoid valve, wherein
an inlet of the first connecting pipeline is in fluid connection with the compressor,
an outlet of the first connecting pipeline is in fluid connection with the first evaporator,
an inlet of the second connecting pipeline is in fluid connection with the inlet of the first connecting pipeline,
an outlet of the second connecting pipeline is in fluid connection with the second evaporator,
the connecting solenoid valve is provided between the inlet of the first connecting pipeline and the inlet of the second connecting pipeline, to control a refrigerant in the compressor to enter into the first evaporator and the second evaporator through the first connecting pipeline and the second connecting pipeline, respectively.

8. The multifunctional ice beverage machine of claim 1, wherein a surface of the side wall of the second evaporator is a rough surface.

9. The multifunctional ice beverage machine of claim 1, wherein a depth direction of the grooves on the surface of the first evaporator is parallel to a horizontal direction.

10. The multifunctional ice beverage machine of claim 1, wherein a withdrawal direction of the ice receiving basket is parallel to an axial direction of the second evaporator.
